(19) United States
(12) Patent Application Publication
(10) Pub. No.: US 2019/0253780 A1
(43) Pub. Date: Aug. 15, 2019

(54) Communication Device for Use with a Personal Protection System

(71) Applicant: MSA Europe GmbH, Jona (CH)

(72) Inventors: Markus Wind, Berlin (DE); Detlef Kielow, Berlin (DE); Elmar Schommer, Berlin (DE); Harold Schurz-Preisser, Berlin (DE)

(21) Appl. No.: 16/323,011

(22) PCT Filed: Sep. 8, 2017
(86) PCT No.: PCT/EP2017/072542

§ 371 Date: Feb. 4, 2019

(30) Foreign Application Priority Data
Sep. 8, 2016 (DE) 10 2016 217 082.1

(51) Int. Cl. H04R 1/08; H04R 1/10; A42B 3/30; H04B 1/3827

(52) U.S. Cl. CPC H04R 1/083; H04R 1/1075; H04R 2201/023; H04B 1/385; H04B 2001/3866; A42B 3/30

(57) ABSTRACT

A communication device for use with a personal protection system includes a microphone module and a loudspeaker module which can be flexibly connected by a connector that allows for an adjustment of the distance between the microphone module and the loudspeaker module. The microphone module includes a housing with at least two sections. A first microphone is arranged in a first housing section and a second microphone is arranged in a second housing section. The first housing section includes an insertion mechanism for inserting the first housing section into the loudspeaker module in a first functional mode or for inserting the first housing section into a receiving element or holding device mounted to a protective head gear device, such as a mask, in a second functional mode.

### CROSS REFERENCE TO RELATED APPLICATION

This application claims priority to German Patent Application No. 10 2016 217 082.1, filed on Sep. 8, 2016, the disclosure of which is incorporated by reference herein in its entirety.

### BACKGROUND OF THE INVENTION

### Field of the Invention

The present invention relates to a communication device for use with at least one personal protection system, a mask for use with a communication device, and a holding device for use with a communication device.

### Description of Related Art

Emergency personnel such as firefighters are required to participate in missions involving different situations that require products for self-protection. In particular, helmets in combination with fire protection jackets and trousers are often required. During use, the helmet is often combined with a respiratory mask which forms part of an air supplying device.

In addition the emergency personnel require good communication devices. During operations the communication between the team leader and the team members is important. Typically analogue or digital wireless communication are used. Specific communication devices are known for applications with a helmet or a helmet-mask combination that are either integrated into the helmet or into the mask.

DE 10 2013 011 195 A1 describes a personnel protection system that includes a helmet with a first microphone device arranged on the helmet and a second microphone device that is arranged at a breathing or respiratory mask. A remote communication device is communicatively connected to the first microphone device. Further connecting devices such as Bluetooth connect the second microphone device with the remote communication device. This communication device is only suitable for a personal protection system consisting of a helmet and a mask.

There is however a need for clear communication in challenging and noisy environments while wearing different personal protection systems that do not include a full mask such as a singular helmet, helmet suspension, head gear, protective glasses or a half mask device.

### SUMMARY OF THE INVENTION

Generally, provided is an improved communication device that can be easily interchanged between different personal protection systems while providing at the same time clear communication that is easily understood.

According to a preferred and non-limiting embodiment, example, or aspect, provided is a communication device for use with at least one personal protection system, in a preferred and non-limiting embodiment, example, or aspect, a head gear device. The communication device includes: at least one microphone module and at least one loudspeaker module, wherein the microphone module and the loudspeaker module are flexibly connected to each other by at least one connector that allows for an adjustment of the distance between the microphone module and the loudspeaker module. The at least one microphone module can include a housing with at least two sections each one having at least one microphone. A first microphone can be arranged in at least one of the housing sections and a second microphone can be arranged in the other housing section. The two microphones can be arranged a predetermined distance to each other within the housings. The first housing section with the first microphone can include an insertion mechanism for inserting the first housing section into the loudspeaker module in a first functional mode or for inserting the first housing section into a receiving element mounted to a protective head gear device, in a preferred and non-limiting embodiment, example, or aspect, a mask, in a second functional mode.

In a preferred and non-limiting embodiment, example, or aspect, the communication device can be used with any head gear device, such as, in a preferred and non-limiting embodiment, example, or aspect, a helmet and its suspension components, protective glasses, a half-mask device, and/or a full-mask device.

In a preferred and non-limiting embodiment, example, or aspect, the communication device can allow for flexible mounting to different head set devices and can provide a large field of applications and options. In a preferred and non-limiting embodiment, example, or aspect, also provided can be the specific combination and flexibility in mounting the communication device and also transferring the communication device to other users. At the same time the communication device can provide clear communication while the user is wearing different personal protection systems in noisy environments.

In a preferred and non-limiting embodiment, example, or aspect, the communication device can allow for clear speaking and understanding through transmitting a signal to a remote speaker microphone that can be connected to a transmitting device (in a preferred and non-limiting embodiment, example, or aspect, a radio, or an LTE mobile). In a preferred and non-limiting embodiment, example, or aspect, the communication device can also enable communications in explosive environments. In a preferred and non-limiting embodiment, example, or aspect, the communication device can also be specifically designed for individual personal protection systems such as masks or helmets while fulfilling the need for close team communication without feedback sounds. In a preferred and non-limiting embodiment, example, or aspect, the communication device can be compatible with different helmets and masks and can also be worn on a head band holder, either on the left or on the right side of the head, and can be mounted and detached easily and quickly.

While known head set solutions offer a good intelligibility, they are mostly mounted and restricted to just one special personal protection system or are inserted into the ear, which may be impractical for users such as, in a preferred and non-limiting embodiment, example, or aspect, firefighters. The ability to switch ears is valuable to users that have a preference between their right ear or left ear.

In a preferred and non-limiting embodiment, example, or aspect, the communication device can offer several advantages including an easy donning and doffing which can allow handing over of the communication device to other teammates, and easy maintenance of the attached personal protection systems. In a preferred and non-limiting embodiment, example, or aspect, the communication device including two microphones has improved speech intelligibility. In a preferred and non-limiting embodiment, example, or aspect, versatile attachment options to different personal protection systems can allow for a secure voice communication device in many different work environments.

In a preferred and non-limiting embodiment, example, or aspect, the at least two housing sections of the microphone module can be designed in a hollow shape, respectively. In a preferred and non-limiting embodiment, example, or aspect, the at least two microphones can be placed or disposed within the hollow shaped housing sections.

In a preferred and non-limiting embodiment, example, or aspect, the two housing sections of the microphone module can be designed as hollow cylinders.

In a preferred and non-limiting embodiment, example, or aspect, the housing sections can have a cylindrical, hexagonal, square-shaped form, or any other suitable shape.

In a preferred and non-limiting embodiment, example, or aspect, both housing sections can be connected to each other in order to form one microphone module or housing. In a preferred and non-limiting embodiment, example, or aspect, one microphone can be disposed in one housing section, and a second microphone can be disposed in the other housing section. In a preferred and non-limiting embodiment, example, or aspect, the housing sections can be connected to each other and form one piece. In a preferred and non-limiting embodiment, example, or aspect, the housing sections with the respective microphone in each section may be arranged in-line (i.e., the two microphones are arranged to each other at an angle of 180°) or on an angle (i.e., the two housing sections are arranged in an angle smaller than 180° such as 100-120° to each other). However, this is not to be construed in a limiting sense since the spatial arrangement of the two housing sections with the respective microphones can be selected to optimize speech and sound quality.

In a preferred and non-limiting embodiment, example, or aspect, the housing of the microphone module may be made of plastic or any other suitable material.

In a preferred and non-limiting embodiment, example, or aspect, the communication device can include an automatic switch for switching between the at least two microphones of the microphone module depending on which functional mode is being used. In a preferred and non-limiting embodiment, example, or aspect, such automatic switch can allow for the use of only one of the microphones depending on the functional mode of the device for a specific personal protection system thereby providing a clear communication signal. In a preferred and non-limiting embodiment, example, or aspect, the automatic switch between the two microphones within the housing of the microphone module can, in a preferred and non-limiting embodiment, example, or aspect, be provided by way of a reed contact or any other similar type of contact switch including, in a preferred and non-limiting embodiment, example, or aspect, a hall effect switch using a magnet. Thus, in a preferred and non-limiting embodiment, example, or aspect, when switching between the functional modes, one or the other of the two microphones can be activated.

In a preferred and non-limiting embodiment, example, or aspect, the two functional modes of the communication device can include a first mode wherein the communication device is mounted to a helmet (without any mask) or to a helmet suspension, and a second functional mode wherein the communication device is mounted to a gas mask or other respiratory mask.

In a preferred and non-limiting embodiment, example, or aspect, in the first functional mode (i.e., the communication device is mounted or attached to a helmet or helmet suspension or an arm band) the first housing section with the first microphone can be inserted into the loudspeaker module. In a preferred and non-limiting embodiment, example, or aspect the first housing section can include at least two slots or slits on opposite sides as an insertion mechanism in order to allow easy sliding of the first housing section into a corresponding receiving element in the loudspeaker module. In a preferred and non-limiting embodiment, example, or aspect, the receiving element can be a pocket provided with projections corresponding to the slots or slits on the first housing section.

In a preferred and non-limiting embodiment, example, or aspect, in the first functional mode, the second housing section with the second microphone may not be inserted into the loudspeaker module and can thus be outside of the loudspeaker module. In a preferred and non-limiting embodiment, example, or aspect, the second microphone (i.e., the microphone that is not inserted into the loudspeaker module) can be used for communication in the first functional mode. Thus, in a preferred and non-limiting embodiment, example, or aspect, the second microphone can pick up the voice of the person wearing the helmet or helmet suspension with the attached communication device directly near the mouth and can subtract noise from the voice signal on a physical based method.

In a preferred and non-limiting embodiment, example, or aspect, in the second functional mode (i.e., communication device mounted or attached to a mask), the first housing section with the first microphone can be inserted into a suitable receiving element (may also be described as an adapter) on the mask for receiving the first housing section with the first microphone of the microphone module. In a preferred and non-limiting embodiment, example, or aspect, the first microphone can automatically be activated (in a preferred and non-limiting embodiment, example, or aspect, by a contact as a switch) when inserted into the mask receiving element or adapter. Thus, in a preferred and non-limiting embodiment, example, or aspect, the first microphone of the first housing section can be inserted into the receiving element on the mask and can be used for communication in the second functional mode.

In a preferred and non-limiting embodiment, example, or aspect, in the second functional mode, the voice can be captured in front of a speech diaphragm and guided into a permanently inserted funnel. In a preferred and non-limiting embodiment, example, or aspect, the funnel can be a part of the mask adapter that can be permanently attached to the mask.

In a preferred and non-limiting embodiment, example, or aspect, each of the at least two microphones of the microphone module can be an electret microphone, a condenser microphone, or a piezoelectric microphone. In a preferred and non-limiting embodiment, example, or aspect, each microphone is desirably an electret microphone. An electret microphone is a type of electrostatic capacitor-based microphone that eliminates the need for a polarizing power supply by using a permanently charged material. Specifically, an electret is a stable dielectric material with a permanently embedded static electric charge (which, due to the high resistance and chemical stability of the material, will not decay for hundreds of years). An advantage of using electret microphones is that the microphones are able to filter ambient noise.

In a preferred and non-limiting embodiment, example, or aspect, one or more electret microphones are desirably used for the free standing arrangement of the microphone module. In a preferred and non-limiting embodiment, example, or aspect, an electret microphone is used for the second microphone used in the first functional mode on a helmet or head support system (i.e., for the second microphone in the second housing section of the communication device that is not inserted into the loudspeaker module and is arranged in front of the mouth of the person wearing the communication device attached to the helmet or head band).

In a preferred and non-limiting embodiment, example, or aspect, the at least one connector between the microphone module and the loudspeaker module can include a wired connection, such as a spiral cable, or a wireless connection, such as, in a preferred and non-limiting embodiment, example, or aspect, Bluetooth. In a preferred and non-limiting embodiment, example, or aspect, the connector can allow for high flexibility regarding direction and length between the microphone module (comprising the housing with the at least two microphones) and the loudspeaker module, especially, in a preferred and non-limiting embodiment, example, or aspect, in the case of the second functional mode (i.e., the communication device used with a helmet and mask).

In a preferred and non-limiting embodiment, example, or aspect, the loudspeaker module can include at least one element for receiving the at least one first housing section of the microphone module with the first microphone. In a preferred and non-limiting embodiment, example, or aspect, and as previously described, the first housing section can include at least two slots or slits on opposite sides in order to allow an easy sliding of the housing section into a corresponding receiving element such as a pocket (provided on the back side of the loudspeaker module) with projections corresponding to the slots or slits on the first housing section. In a preferred and non-limiting embodiment, example, or aspect, the receiving element of the loudspeaker module can allow for the easy insertion of the first housing section into the loudspeaker module, in a preferred and non-limiting embodiment, example, or aspect, by sliding.

In a preferred and non-limiting embodiment, example, or aspect, the first housing section of the microphone module may be held in place in the loudspeaker module by way of a clip, such as, in a preferred and non-limiting embodiment, example, or aspect, a release clip or a spring clip. In a preferred and non-limiting embodiment, example, or aspect, the clip can be arranged on the backside of the loudspeaker module. In a preferred and non-limiting embodiment, example, or aspect, the microphone module can be removed from the first receiving element by overcoming the spring clip.

In a preferred and non-limiting embodiment, example, or aspect, the loudspeaker module can include at least one further mechanism for detachable connection of the loudspeaker module to at least one holding device that can be attached to a head gear device, such as, in a preferred and non-limiting embodiment, example, or aspect, a helmet, a head support system, helmet suspension, protective glasses, a half-mask and/or a full-mask device. In a preferred and non-limiting embodiment, example, or aspect, the at least one further mechanism for detachable connection may be configured as a receiving mechanism for an element of a holding device (in a preferred and non-limiting embodiment, example, or aspect, in the form of a pocket). In a preferred and non-limiting embodiment, example, or aspect, there may be at least two pockets formed on the back side of the loudspeaker module as the receiving mechanism. In a preferred and non-limiting embodiment, example, or aspect, the pockets can be placed on the end of the backside of the loudspeaker module opposite to the (first) receiving element on the loudspeaker module for mating with the microphone module. In a preferred and non-limiting embodiment, example, or aspect, the two pockets can be placed (in a mirror image) along the longitudinal sides of the loudspeaker module. This can allow a switching of the wearing positions of the loudspeaker module and thus the communication device. In a preferred and non-limiting embodiment, example, or aspect, the communication device may be worn either on the left or on the right side of a person's head. The pockets can also allow for easy mounting and demounting of the communication device to a head gear device.

In a preferred and non-limiting embodiment, example, or aspect, the loudspeaker module can include an unlocking element for unlocking the loudspeaker module from the holding device. In a preferred and non-limiting embodiment, example, or aspect, by pressing the unlocking element the complete loudspeaker module (including the microphone module if attached) can be removed from the holding device (such as, in a preferred and non-limiting embodiment, example, or aspect, a swivel) attached to a head gear device (such as, in a preferred and non-limiting embodiment, example, or aspect, a helmet).

According to a preferred and non-limiting embodiment, example, or aspect, also provided is a mask (i.e., gas or respiratory mask) as part of a head gear device for use with the at least one communication device as described herein.

In a preferred and non-limiting embodiment, example, or aspect, the mask can include at least one receiving element on the outer surface of a mask grill of the mask for receiving the first housing section of the microphone module with the first microphone, at least one speech membrane or speech diaphragm for registering human speech on the inside of the mask, and at least one sound transmitting device for funneling the sound from the at least one speech membrane, and desirably through the mask grill to the first microphone of the microphone module.

In a preferred and non-limiting embodiment, example, or aspect, the sound transmitting device can be designed and located such that the sound is funneled from the speech membrane directly to the location of the first microphone that is arranged in the receiving element (or adapter) provided on the outer surface of the mask. In a preferred and non-limiting embodiment, example, or aspect, the sound transmitting device can be connected to the mask receiving element of the head gear.

In a preferred and non-limiting embodiment, example, or aspect, the at least one sound transmitting device can be provided as a sound channel, a sound funnel, a wire coupling and/or a wireless coupling. In a preferred and non-limiting embodiment, example, or aspect, the at least one sound transmitting device can be a sound funnel made of any suitable synthetic material, such as silicon, rubber or any plastic material.

According to a preferred and non-limiting embodiment, example, or aspect, a holding device for detachably mounting a communication device to at least one head gear device is provided that includes at least two parts: at least one swivel mechanism for receiving the at least one loudspeaker module of the device and at least one adapter allowing for the mounting of the swivel mechanism with, in a preferred and non-limiting embodiment, example, or aspect, the loudspeaker module, to the at least one head gear device.

In a preferred and non-limiting embodiment, example, or aspect, the swivel mechanism (in a preferred and non-limiting embodiment, example, or aspect) shaped as a latch can be inserted into at least one further (second) receiving element (in a preferred and non-limiting embodiment, example, or aspect, in the form of a pocket or a slit or slot) provided at the loudspeaker module for detachably connecting the loudspeaker module to the holding device. In a preferred and non-limiting embodiment, example, or aspect, this can be done by sliding the swivel arm of the holding device into a pocket provided as the receiving element of the loudspeaker module.

In a preferred and non-limiting embodiment, example, or aspect, the holding device can allow for flexible use of the communication device. In a preferred and non-limiting embodiment, example, or aspect, the holding device can allow for easy interchange of the communication device between different head gear devices. In a preferred and non-limiting embodiment, example, or aspect, the swivel mechanism can be in the form of a swivel arm or a pivoting arm for receiving the loudspeaker module of the communication device to provide a way of connecting the communication device to any type of personal protection system in a universal manner

In a preferred and non-limiting embodiment, example, or aspect, the at least one mounting adapter can form a part of the holding device and can be attachable to a helmet, a head support system (head band), protective glasses, a half-mask and/or a full-mask device.

In a preferred and non-limiting embodiment, example, or aspect, the at least one mounting adapter may be constructed like a clamp for attachment to a band or strap of a helmet or mask. In a preferred and non-limiting embodiment, example, or aspect, the mounting adapter may also be constructed with a mounting mechanism such that it can be directly fixed or attached to a helmet. In a preferred and non-limiting embodiment, example, or aspect, the at least one mounting adapter can be positioned on either the left or the right side of the head gear device.

In a preferred and non-limiting embodiment, example, or aspect, the mounting adapter can include a receiving element for receiving a swivel mechanism. In a preferred and non-limiting embodiment, example, or aspect, the swivel mechanism can be a swivel arm. In a preferred and non-limiting embodiment, example, or aspect, the receiving element can be shaped as a hollow cylinder that has at least a partial opening along the height of the hollow cylinder. In a preferred and non-limiting embodiment, example, or aspect, the at least one swivel mechanism can be shaped as a latch (thin bar or thin latch), wherein at least one end of the latch can be shaped as a cylinder head.

In a preferred and non-limiting embodiment, example, or aspect, the cylinder head of the swivel arm and the hollow cylinder of the receiving element can be dimensioned such that the cylinder head of the swivel arm can be easily inserted (in a preferred and non-limiting embodiment, example, or aspect by sliding) into the hollow cylinder as the receiving element of the mounting adapter. In a preferred and non-limiting embodiment, example, or aspect, the cylinder head of the swivel arm can be rotatably stored within the hollow cylinder in order to allow for movement of the swivel arm and thus movement and adaptation of the arrangement of the loudspeaker module (as part of the communication device) to the person wearing the personal protection gear.

In a preferred and non-limiting embodiment, example, or aspect, the specific construction or design of the latch in conjunction with the receiving element of the mounting adapter can enable the microphone module to be positioned in a working position with a first movement and moved from that working position with a second movement which is in the opposite direction of the first movement.

In a preferred and non-limiting embodiment, example, or aspect, an opposite construction of the swivel mechanism and mounting adapter is also conceivable. Thus, in a preferred and non-limiting embodiment, example, or aspect of the holding device, the swivel mechanism in the form of a latch can include at one end a receiving element in the form of a hollow cylinder for receiving a cylinder that is part of the mounting adapter.

In a preferred and non-limiting embodiment, example, or aspect, at least one flashlight, camera, monitor and/or wireless telephone can be connected to the holding device. In a preferred and non-limiting embodiment, example, or aspect, the holding device can be provided with a device for a push-to-talk connection and/or at least one identification element, such as, in a preferred and non-limiting embodiment, example, or aspect, an RFID tag.

According to a preferred and non-limiting embodiment, example, or aspect, also provided is a communication device for use with at least one personal protection system, in particular with a head protection device. The communication device comprises: at least one microphone module and at least one loudspeaker module, wherein the microphone module and the loudspeaker module are flexibly connected to each other by at least one connector that allows for an adjustment of the distance between the microphone module and the loudspeaker module; wherein the at least one microphone module comprises a housing with at least two sections each one having at least one microphone; wherein a first microphone is arranged in at least one of the housing sections and a second microphone is arranged in the other housing section, wherein the at least two microphones are arranged in a predetermined distance to each other within the housing; and wherein at least one housing section with the first microphone comprises insertion mechanism for inserting the first housing section into the loudspeaker module in a first functional mode or for inserting the first housing section into a receiving element mounted to a protective head gear device, in particular, a mask, in a second functional mode.

In a preferred and non-limiting embodiment, example, or aspect, the at least two housing sections of the microphone module can be designed in a hollow shape, respectively, and the at least two microphones can be placed within the hollow shaped housing sections.

In a preferred and non-limiting embodiment, example, or aspect, the communication device can include an automatic switch between the at least two microphones of the microphone module depending on the functional mode being used.

In a preferred and non-limiting embodiment, example, or aspect, one of the at least two microphones of the microphone module can be an electret microphone, condenser microphone or piezoelectric microphone.

In a preferred and non-limiting embodiment, example, or aspect, the at least one connector between the microphone module and the loudspeaker module can be a cable or a wireless connection.

In a preferred and non-limiting embodiment, example, or aspect, the loudspeaker module can include at least one receiving mechanism for receiving the at least one first housing section of the microphone module with the first microphone.

In a preferred and non-limiting embodiment, example, or aspect, the loudspeaker module can include at least one further receiving mechanism for detachably connecting the loudspeaker module to at least one holding device that can be attached to a head gear device, in particular to a helmet, a head support system, protective glasses, a half-mask and/or a full-mask device.

According to a preferred and non-limiting embodiment, example, or aspect, also provided is a mask as part of a protective head gear device for use with at least one communication device described above. The mask comprises at least one receiving element on the outer surface of the mask grill of the mask for receiving the first housing section of the microphone module with the first microphone; at least one speech membrane for registering human speech on the inside of the mask; and at least one sound transmitting device for funneling the sound from the at least one speech membrane, and preferably through the mask grill to the first microphone of the microphone module.

In a preferred and non-limiting embodiment, example, or aspect, the at least one sound transmitting device can be a sound channel, a sound funnel, a wire coupling and/or a wireless coupling.

In a preferred and non-limiting embodiment, example, or aspect, the at least one sound transmitting device can be a sound funnel that can be made of a synthetic material.

According to a preferred and non-limiting embodiment, example, or aspect, also provided is a holding device for detachably mounting at least one communication device described above to at least one head gear device. The holding device comprises at least one swivel mechanism for receiving the at least one loudspeaker module of the device and at least one mounting adapter allowing for the mounting of the swivel mechanism with the loudspeaker module to the at least one head gear device.

In a preferred and non-limiting embodiment, example, or aspect, the at least one mounting adapter can be attached to a helmet, a head support system, protective glasses, a half-mask and/or a full-mask device.

In a preferred and non-limiting embodiment, example, or aspect, the at least one mounting adapter can include a receiving element for receiving the at least one swivel mechanism.

In a preferred and non-limiting embodiment, example, or aspect, the receiving element can be shaped as a hollow cylinder that has at least a partial opening along the height h of the hollow cylinder.

In a preferred and non-limiting embodiment, example, or aspect, the at least one swivel mechanism can be shaped as a latch wherein at least one end of the latch can be shaped as a cylinder head.

According to a preferred and non-limiting embodiment, example, or aspect, also provided is a communication device comprising: a loudspeaker module; a microphone module comprising a housing including first and second housing sections and first and second microphones in the first and second housing sections; and a connector connecting the loudspeaker module and the microphone module, wherein the first housing section is configured to be attached to the loudspeaker module in a first functional mode or to a receiving element of a protective head gear device in a second functional mode.

In a preferred and non-limiting embodiment, example, or aspect, a spatial arrangement between the first and second microphones can be adjusted.

In a preferred and non-limiting embodiment, example, or aspect, the first and second microphones can be arranged a predetermined distance to each other.

In a preferred and non-limiting embodiment, example, or aspect, the first housing section can include an insertion mechanism for insertion into the loudspeaker module.

In a preferred and non-limiting embodiment, example, or aspect, the loudspeaker module can include at least one receiving mechanism for receiving the insertion mechanism of the first housing section in the first functional mode.

In a preferred and non-limiting embodiment, example, or aspect, the first housing section can include an insertion mechanism for insertion into the receiving element of the protective head gear device in the second functional mode.

In a preferred and non-limiting embodiment, example, or aspect, at least one of the first and second microphones can be an electret microphone, a condenser microphone, or a piezoelectric microphone.

In a preferred and non-limiting embodiment, example, or aspect, the connector between the loudspeaker module and the microphone module can include a cable or a wireless connection.

In a preferred and non-limiting embodiment, example, or aspect, the first and second microphones can be received in the first and second housing sections.

According to a preferred and non-limiting embodiment, example, or aspect, also provided is mask for a head gear device, the mask comprising: a receiving element on an outer surface of the mask; a communication device including a loudspeaker module, a microphone module including a housing having first and second housing sections and first and second microphones in the first and second housing sections, and a connector connecting the loudspeaker module and the microphone module, wherein the first housing section is configured to be attached to the receiving element on the outer surface of the mask; a speech membrane for registering a sound on the inside of the mask; and a sound transmitting device for funneling the sound from the speech membrane, through a mask grill of the mask to the first microphone of the first housing section attached to the receiving element on an outer surface of the mask.

In a preferred and non-limiting embodiment, example, or aspect, the connector between the microphone module and the loudspeaker module can be a cable or a wireless connection.

In a preferred and non-limiting embodiment, example, or aspect, the sound transmitting device can be a sound channel, a sound funnel, a wire coupling, and/or a wireless coupling.

In a preferred and non-limiting embodiment, example, or aspect, the sound transmitting device can be a sound funnel made of a synthetic material.

In a preferred and non-limiting embodiment, example, or aspect, the loudspeaker module can include at least one receiving mechanism for receiving the first housing section of the microphone module with the first microphone.

According to a preferred and non-limiting embodiment, example, or aspect, also provided is a holding device for a head gear device, the holding device comprising: a swivel mechanism for receiving a receiving element of a loudspeaker module of a communication device; and a mounting adapter for mounting the swivel mechanism with the loudspeaker module to the head gear device.

In a preferred and non-limiting embodiment, example, or aspect, the communication device can include a microphone module including a housing having first and second housing sections and first and second microphones in the first and second housing sections, and a connector connecting the loudspeaker module and the microphone module.

In a preferred and non-limiting embodiment, example, or aspect, the head gear device can be a helmet, a head support system, protective glasses, a half-mask, and/or a full-mask device.

In a preferred and non-limiting embodiment, example, or aspect, the mounting adapter can include a receiving element for receiving the swivel mechanism.

In a preferred and non-limiting embodiment, example, or aspect, the mounting adapter receiving element can be a hollow cylinder that has at least a partial opening along a height of the hollow cylinder.

In a preferred and non-limiting embodiment, example, or aspect, the swivel mechanism can be shaped as a latch wherein at least one end of the latch can be shaped as a cylinder head.

Further preferred and non-limiting embodiments, examples, or aspects are set forth in the following numbered clauses.

Clause 1: A communication device for use with at least one personal protection system, in particular with a head protection device, comprising: at least one microphone module and at least one loudspeaker module, wherein the microphone module and the loudspeaker module are flexibly connected to each other by at least one connector that allows for an adjustment of the distance between the microphone module and the loudspeaker module; wherein the at least one microphone module includes a housing with at least two sections each one having at least one microphone; wherein a first microphone is arranged in at least one of the housing sections and a second microphone is arranged in the other housing section, wherein the at least two microphones are arranged a predetermined distance to each other within the housing; wherein at least one housing section with the first microphone includes insertion mechanism for inserting the first housing section into the loudspeaker module in a first functional mode or for inserting the first housing section into a receiving element mounted to a protective head gear device, in particular a mask, in a second functional mode.

Clause 2: The communication device of clause 1, wherein the at least two housing sections of the microphone module can be designed in a hollow shape, respectively, and the at least two microphones can be placed within the hollow shaped housing sections.

Clause 3: The communication device of clause 1 or 2, wherein the communication device can further include an automatic switch between the at least two microphones of the microphone module depending on the functional mode being used.

Clause 4: The communication device of any one of clauses 1-3, wherein one of the at least two microphones of the microphone module can be an electret microphone, a condenser microphone, or a piezoelectric microphone.

Clause 5: The communication device of any one of clauses 1-4, wherein the at least one connector between the microphone module and the loudspeaker module can include a cable or a wireless connection.

Clause 6: The communication device of any one of clauses 1-5, wherein the loudspeaker module can include at least one receiving mechanism for receiving the at least one first housing section of the microphone module with the first microphone.

Clause 7: The communication device of any one of clauses 1-6, wherein the loudspeaker module can include at least one further receiving mechanism for detachably connecting the loudspeaker module to at least one holding device that can be attached to a head gear device, such as, in a preferred and non-limiting embodiment, example, or aspect, a helmet, a head support system, protective glasses, a half-mask and/or a full-mask device.

Clause 8: A mask as part of a protective head gear device for use with the communication device of any one of clauses 1-7, comprising at least one receiving element on the outer surface of the mask grill of the mask for receiving the first housing section of the microphone module with the first microphone, at least one speech membrane for registering human speech on the inside of the mask, and at least one sound transmitting device for funneling the sound from the at least one speech membrane, and through the mask grill to the first microphone of the microphone module.

Clause 9: The mask of clause 8, wherein the at least one sound transmitting device can be provided as a sound channel, a sound funnel, a wire coupling and/or a wireless coupling.

Clause 10: The mask of clause 8 or 9, wherein the at least one sound transmitting device can be a sound funnel made of a synthetic material.

Clause 11: A holding device for detachably mounting the communication device of any one of clauses 1-7 to at least one head gear device, comprising at least one swivel mechanism for receiving the at least one loudspeaker module of the device and at least one mounting adapter allowing for the mounting of the swivel mechanism with the loudspeaker module to the at least one head gear device.

Clause 12: The holding device of clause 11, wherein the at least one mounting adapter can be attachable to a helmet, a head support system (head band), protective glasses, a half-mask and/or a full-mask device.

Clause 13: The holding device of clause 11 or 12, wherein the at least one mounting adapter can include a receiving element for receiving the at least one swivel arm.

Clause 14: The holding device of any one of clauses 11-13, wherein the receiving element can be shaped as a hollow cylinder that has at least a partial opening along the height of the hollow cylinder.

Clause 15: The holding device of any one of clauses 11-14, wherein the at least one swivel mechanism can be shaped as a latch wherein at least one end of the latch is shaped as a cylinder head.

Clause 16: A communication device comprising: a loudspeaker module; a microphone module comprising a housing including first and second housing sections and first and second microphones in the first and second housing sections; and a connector connecting the loudspeaker module and the microphone module, wherein the first housing section is attached to the loudspeaker module in a first functional mode or to a receiving element of a protective head gear device in a second functional mode.

Clause 17: The communication device of clause 16, wherein a spatial arrangement between the first and second microphones can be adjustable.

Clause 18: The communication device of clause 16 or 17, wherein the first and second microphones can be arranged a predetermined distance to each other.

Clause 19: The communication device of any one of clauses 16-18, wherein the first housing section can include an insertion mechanism for insertion into the loudspeaker module.

Clause 20: The communication device of any one of clauses 16-19, wherein the loudspeaker module can include at least one receiving mechanism for receiving the insertion mechanism of the first housing section in the first functional mode.

Clause 21: The communication device of any one of clauses 16-20, wherein the first housing section can include an insertion mechanism for insertion into the receiving element of the protective head gear device in the second functional mode.

Clause 22: The communication device of any one of clauses 16-21, wherein one of the at least two microphones can be an electret microphone, a condenser microphone, or a piezoelectric microphone.

Clause 23: The communication device of any one of clauses 16-22, wherein the connector between the loudspeaker module and the microphone module comprises a cable or a wireless connection.

Clause 24: The communication device of any one of clauses 16-23, wherein the first and second microphones are received in the first and second housing sections.

Clause 25: A mask for a head gear device, the mask comprising: a receiving element on an outer surface of the mask; a communication device including a loudspeaker module, a microphone module including a housing having first and second housing sections and first and second microphones in the first and second housing sections, and a connector connecting the loudspeaker module and the microphone module, wherein the first housing section is attached to the receiving element on the outer surface of the mask; a speech membrane for registering a sound on the inside of the mask; and a sound transmitting device for funneling the sound from the speech membrane, through a mask grill of the mask to the first microphone of the first housing section attached to the receiving element on an outer surface of the mask.

Clause 26: The mask of clause 25, wherein the connector between the microphone module and the loudspeaker module can include a cable or a wireless connection.

Clause 27: The mask of clause 25 or 26, wherein the sound transmitting device can be a sound channel, a sound funnel, a wire coupling, and/or a wireless coupling.

Clause 28: The mask of any one of clauses 25-27, wherein the sound transmitting device can be sound funnel made of a synthetic material.

Clause 29: The mask of any one of clauses 25-28, wherein the loudspeaker module can include at least one receiving mechanism for receiving the first housing section of the microphone module with the first microphone.

Clause 30: A holding device for a head gear device, the holding device comprising: a swivel mechanism for receiving a receiving element of a loudspeaker module of a communication device; and a mounting adapter for mounting the swivel mechanism with the loudspeaker module to the head gear device.

Clause 31: The holding device of clause 30, wherein the communication device includes a microphone module including a housing having first and second housing sections and first and second microphones in the first and second housing sections, and a connector connecting the loudspeaker module and the microphone module.

Clause 32: The holding device of clause 30 or 31, wherein the mounting adapter is attachable to a helmet, a head support system, protective glasses, a half-mask, and/or a full-mask device.

Clause 33: The holding device of any one of clauses 30-32, wherein the mounting adapter includes a receiving element for receiving the swivel mechanism.

Clause 34: The holding device of any one of clauses 30-33, wherein the mounting adapter receiving element can be hollow cylinder that has at least a partial opening along a height of the hollow cylinder.

Clause 35: The holding device of any one of clauses 30-34, wherein the swivel mechanism is shaped as a latch wherein at least one end of the latch is shaped as a cylinder head.

### BRIEF DESCRIPTION OF THE DRAWINGS

Additional advantages and details of the invention are explained in greater detail below with reference to the exemplary preferred and non-limiting embodiments, examples, or aspects that are illustrated in the accompanying schematic figures, in which:

FIG. 1A is a top view of an embodiment, example, or aspect communication device according to the principles of the present invention;

FIG. 1B is a back view of an embodiment, example, or aspect communication device according to the principles of the present invention;

FIG. 2 is a perspective view of an embodiment, example, or aspect communication device according to the principles of the present invention attached to an embodiment of a helmet in accordance with a first functional mode according to the principles of the present invention;

FIG. 3A is a perspective view of an embodiment, example, or aspect communication device according to the principles of the present invention attached to an embodiment of a respiratory mask in accordance with a second functional mode according to the principles of the present invention;

FIG. 3B is a schematic view of an embodiment, example, or aspect communication device according to the principles of the present invention integrated into the embodiment of the respiratory mask of FIG. 3A;

FIG. 4A is a perspective view of an embodiment, example, or aspect holding device according to the principles of the present invention; and

FIG. 4B is a perspective view another embodiment, example, or aspect holding device according to the principles of the present invention.

### DESCRIPTION OF THE INVENTION

For the purposes of the following detailed description, it is to be understood that the invention may assume various alternative variations and step sequences, except where expressly specified to the contrary. It is also to be understood that the specific devices and methods described in the following specification are simply exemplary embodiments, examples, or aspects. Moreover, other than in any operating examples, or where otherwise indicated, all numbers expressing, in preferred and non-limiting embodiments, examples, or aspects, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the Doctrine of Equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

It is to be understood that the invention may assume various alternative variations and step sequences, except where expressly specified to the contrary. It is also to be understood that the specific devices and processes illustrated in the attached drawings, and described in the following specification, are simply exemplary embodiments, examples, or aspects of the invention. Hence, specific dimensions and other physical characteristics related to the embodiments, examples, or aspects disclosed herein are not to be considered as limiting. Certain preferred and non-limiting embodiments, examples, or aspects of the present invention will be described with reference to the accompanying figures where like reference numbers correspond to like or functionally equivalent elements.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances. Further, in this application, the use of “a” or “an” means “at least one” unless specifically stated otherwise.

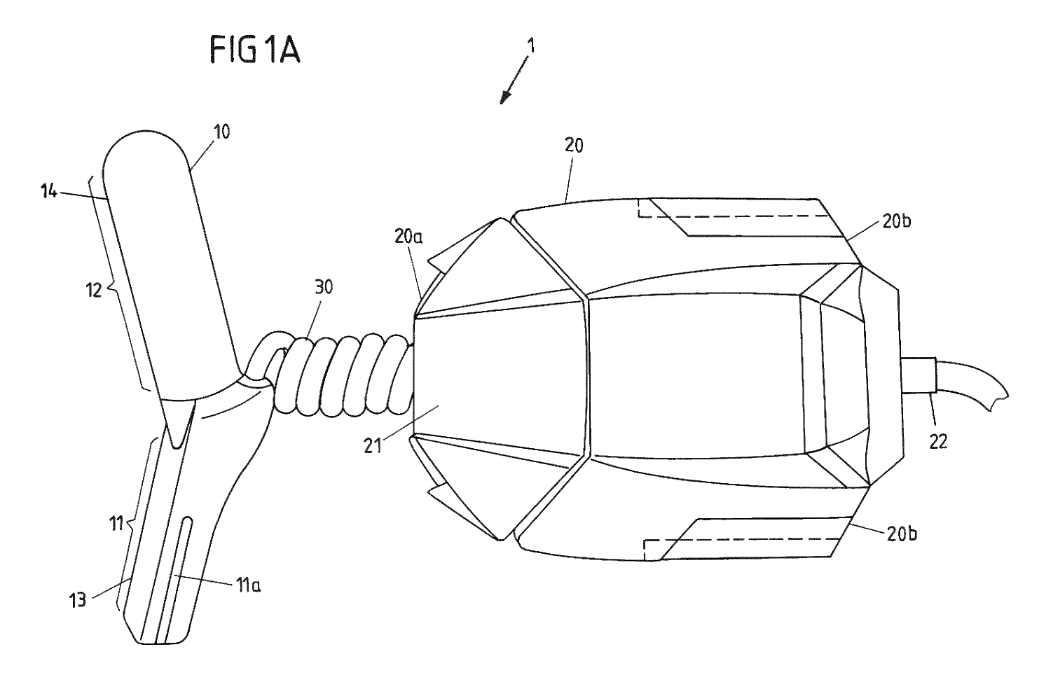

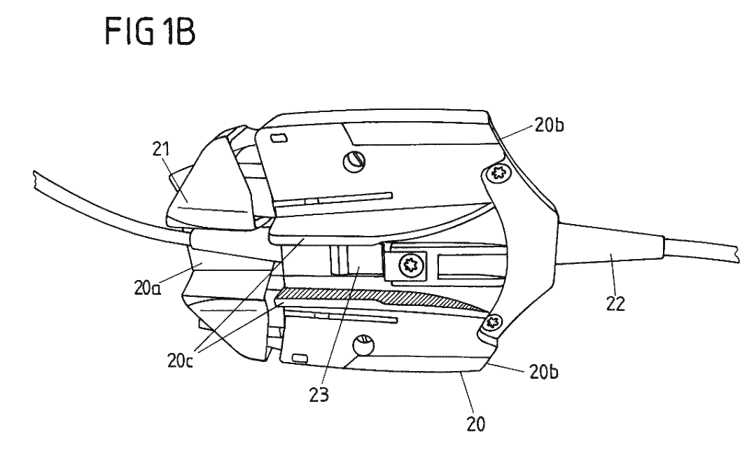

The present disclosure is directed to communication device for use with at least one personal protection system. FIGS. 1A and 1B show a preferred and non-limiting embodiment, example, or aspect, of a communication device 1 for use with at least one personal protection system, such as, in a preferred and non-limiting embodiment, example, or aspect, a head protection device, such as a fire helmet.

Generally, the communication device 1 includes one microphone module 10 and one loudspeaker module 20, wherein the microphone module 10 and the loudspeaker module 20 are flexibly connected to each other by a connector 30 that allows for an adjustment of the distance between the microphone module 10 and the loudspeaker module 20. A coiled cable can serve as such connector 30. However, the description of connector 30 being a coiled cable is not to be construed in a limiting sense, since it is envisioned that connector 30 can be a wireless connection such as, in a preferred and non-limiting embodiment, example, or aspect, a Bluetooth connection.

With reference to FIG. 1A, in a preferred and non-limiting embodiment, example, or aspect, microphone module 10 can include a housing with two sections 11, 12. In each of the sections there is one microphone 13, 14 provided. Thus, the first microphone 13 is arranged in the first housing section 11 and the second microphone 14 is arranged in the second housing section 12. Due to the arrangement in a housing made of, in a preferred and non-limiting embodiment, example, or aspect, a rigid plastic material, the two microphones 13, 14 can be arranged a predetermined distance to each other within the housing. The distance of the microphones as well as the spatial arrangement (angle) between the microphones can be, however, adjustable, in a preferred and non-limiting embodiment, example, or aspect, to the respective user. In a preferred and non-limiting embodiment, example, or aspect, the second microphone 14 can be an electret microphone.

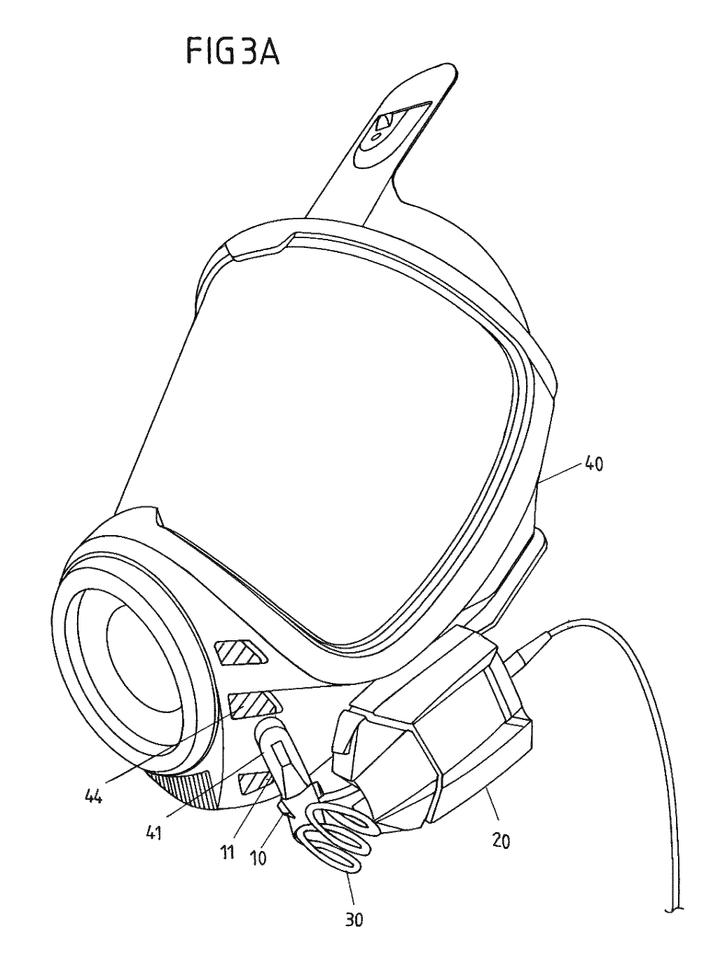

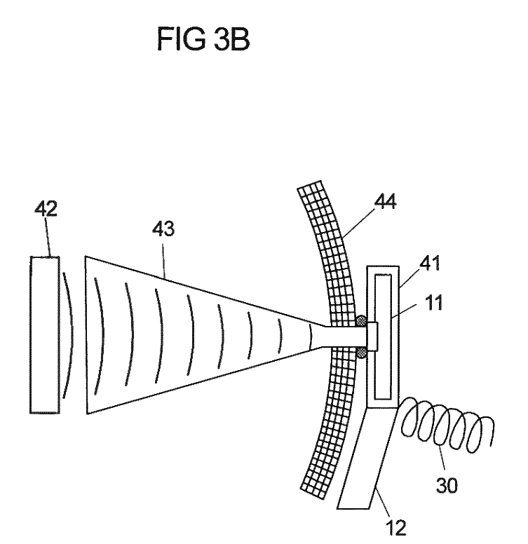

In a preferred and non-limiting embodiment, example, or aspect, the first housing section 11 with the first microphone 13 can include an insertion mechanism 11a for attaching the first housing section 11 to the loudspeaker module 20 in a first functional mode or to an adapter 41 mounted to a face piece, in particular a mask 40 in a second functional mode (see FIG. 3A). In a preferred and non-limiting embodiment, example, or aspect, the insertion mechanism 11a can be shaped as two slots or grooves within the housing wall.

In a preferred and non-limiting embodiment, example, or aspect, the two housing sections 11, 12 of the microphone module 10 can be designed as hollow cylinders, respectively, and the at least two microphones can be placed within the hollow cylinders which are connected to each other in order to form one module housing.

With reference to FIG. 1B and with continuing reference to FIG. 1A, in a preferred and non-limiting embodiment, example, or aspect, the loudspeaker module 20 can include one first receiving element 20a for receiving the first housing section 11 of the microphone module 10 with the first microphone 13. In a preferred and non-limiting embodiment, example, or aspect, the first receiving element 20a can be shaped as a pocket with two projections 20c corresponding to the two slots 11a of the first housing section. This allows for sliding or pushing of the first housing section 11 into the pocket of the loudspeaker module 20.

In a preferred and non-limiting embodiment, example, or aspect, the first housing section 11 of the microphone module 10 can be held in place in the receiving element 20a by a release spring 23. The spring 23 can be arranged on the backside of the loudspeaker module (see FIG. 1B). The microphone module may be removed (or slid) from the first receiving element 20a by overcoming the spring clip 23.

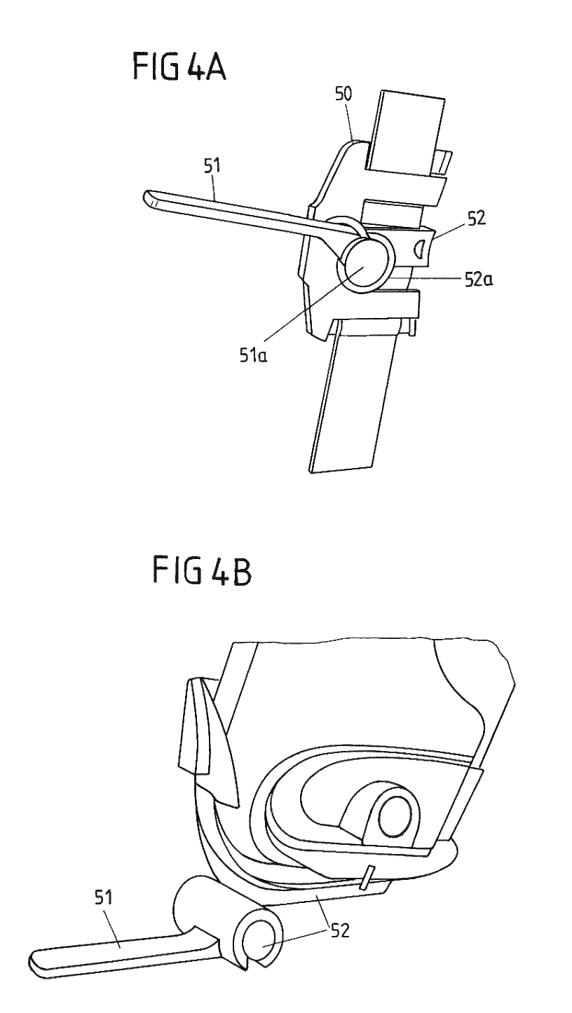

In a preferred and non-limiting embodiment, example, or aspect, the loudspeaker module 20 can include two second receiving elements 20b for receiving a swivel arm 51 of a holding device 50 for holding and fastening the communication device 1 to a helmet or helmet suspension (see also FIGS. 4A, 4B). In a preferred and non-limiting embodiment, example, or aspect, the second receiving elements 20b can be shaped as a pocket with projections that allow for an easy sliding of the loudspeaker module 20 onto the swivel arm 51 of the holding device 50. Furthermore, in a preferred and non-limiting embodiment, example, or aspect, the two pockets 20b can placed along the longitudinal sides of the loudspeaker module. This allows switching of the wearing positions of the loudspeaker module 20 and thus the communication device 1.

In a preferred and non-limiting embodiment, example, or aspect, the loudspeaker module 20 can further include an unlocking mechanism 21 for unlocking the loudspeaker module (including the microphone module) from the swivel arm 51 of the holding device 50 (see also FIGS. 4A, 4B). By pressing the unlocking mechanism 21, the complete loudspeaker module 20 (including the microphone module 10 if attached) may be removed from the holding device 50 (such as a swivel arm) attached to a head protection device such as, in a preferred and non-limiting embodiment, example, or aspect, a helmet. In a preferred and non-limiting embodiment, example, or aspect, a cable 22 can be fastened to the loudspeaker module 20 to provide a connection to a remote communication device such as a mobile phone or a radio device (not shown).

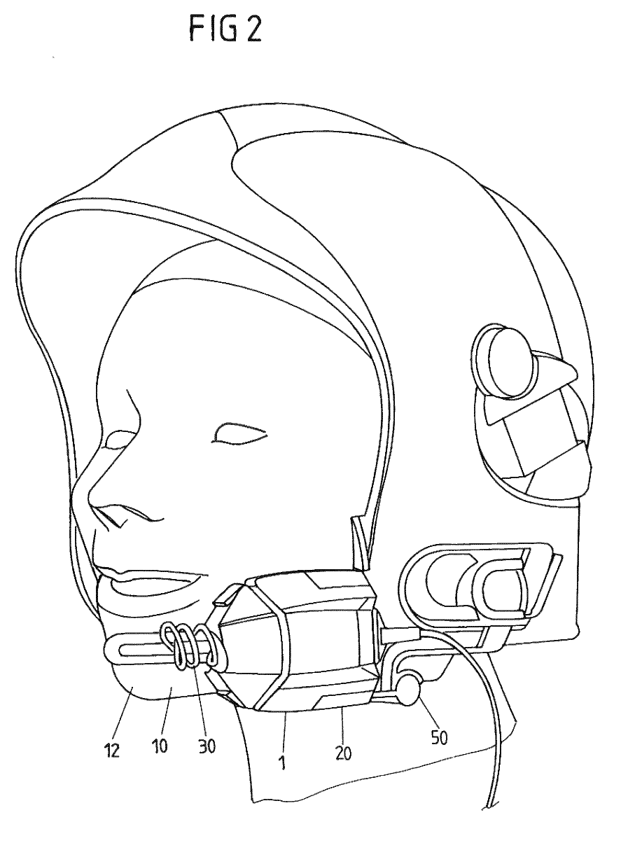

In a preferred and non-limiting embodiment, example, or aspect, the communication device 1 can be used in two different functional modes: a first mode wherein the communication device 1 is mounted to a helmet (without any mask) (see FIG. 2) and a second functional mode wherein the communication device 1 is mounted to a mask 40, such as, in a preferred and non-limiting embodiment, example, or aspect, a gas mask or a respiratory mask (see FIG. 3A).

In a preferred and non-limiting embodiment, example, or aspect of the first functional mode shown in FIG. 2 (i.e., communication device 1 mounted or attached to a helmet), the first housing section 11 with the first microphone 13 can be inserted into the loudspeaker module 20. The second housing section 12 with the second microphone 14 is not inserted into the loudspeaker module 20 and is thus outside of the loudspeaker module 20. The second microphone 14 in the second housing section 12, i.e., the microphone that is not inserted into the loudspeaker module, is used for communication. The second microphone 14 can be activated automatically. In a preferred and non-limiting embodiment, example, or aspect, the second microphone 14 can pick up the voice of the person wearing the helmet since the attached communication device is located near the mouth.

In a preferred and non-limiting embodiment, example, or aspect of the second functional mode shown in FIG. 3A, the communication device 1 can be mounted or attached to a mask 40. In a preferred and non-limiting embodiment, example, or aspect, the mask 40 can be part of a face piece having one receiving element 41 on an outer surface of a mask grill 44 for receiving the first housing section 11 of the microphone module 10 with the first microphone 13.

In a preferred and non-limiting embodiment, example, or aspect, the mask 40 can further include one speech membrane or speech diaphragm 42 for registering human speech on the inside of the mask 40, and one sound transmitting device 43 for funneling the sound from the speech diaphragm 42, and through the mask grill 44 to the first microphone 13 of the microphone module 10 (see FIG. 3B).

In a preferred and non-limiting embodiment, example, or aspect, in the second functional mode as illustrated in FIGS. 3A, 3B, the first housing section 11 with the first microphone 13 can be inserted into the receiving element 41 on the mask 40. In a preferred and non-limiting embodiment, example, or aspect, the first microphone 13 can be automatically activated by a contact switch (such as a reed contact) when inserted into the mask adapter or receiving element 41. In a preferred and non-limiting embodiment, example, or aspect, the contact switch can be specifically activated when the microphone module 10 is removed from the loudspeaker module 20.

In a preferred and non-limiting embodiment, example, or aspect, the user's voice can be captured in front of the speech diaphragm 42 using a funnel or cone shaped member 43. In a preferred and non-limiting embodiment, example, or aspect, the funnel 43 can be a part of the mask adapter or receiving element 41 that can be permanently attached to the mask 40 or can also be detached from the mask 40. In a preferred and non-limiting embodiment, example, or aspect, the funnel 43 can be made of a synthetic material such as, in a preferred and non-limiting embodiment, example, or aspect, silicon or rubber or any suitable plastic material.

With reference to FIGS. 4A and 4B there is shown preferred and non-limiting embodiments, examples, or aspects, of a holding device 50 for detachably mounting the communication device 1 to a helmet or a head band. In a preferred and non-limiting embodiment, example, or aspect, the holding device 50 can include one swivel mechanism 51 in the form of a latch for receiving the loudspeaker module 20 of the device (see also FIG. 2) and one mounting adapter 52 allowing mounting of the swivel mechanism with the loudspeaker module to the head band (FIG. 4A) or a helmet (FIG. 4B).

In a preferred and non-limiting embodiment, example, or aspect, the mounting adapter 52 may be constructed like a clamp for attachment to a band or strap of a helmet or mask. In a preferred and non-limiting embodiment, example, or aspect, the mounting adapter 52 may also be constructed with a mounting mechanism such that it can be directly fixed or attached to a helmet.

In a preferred and non-limiting embodiment, example, or aspect shown in FIG. 4A, the mounting adapter 52 can include a receiving element 52a for receiving the at least one swivel arm 51. In a preferred and non-limiting embodiment, example, or aspect, the receiving element 52a can be shaped as a hollow cylinder that has at least a partial opening along the height of the hollow cylinder.

In a preferred and non-limiting embodiment, example, or aspect, one end of the latch of the swivel arm 51 can be shaped as a cylinder head 51a.

In a preferred and non-limiting embodiment, example, or aspect, the cylinder head 51a of the swivel arm 51 and the hollow cylinder as the receiving element 52a of the mounting adapter 52 can be dimensioned such that the cylinder head 51a of the swivel arm can be easily inserted, in a preferred and non-limiting embodiment, example, or aspect, by sliding into the hollow cylinder of the receiving element 52a of the mounting adapter. In a preferred and non-limiting embodiment, example, or aspect, the cylinder head 51a of the swivel arm can be rotatably stored within the hollow cylinder 52a in order to allow for easy movement of the swivel arm 51 and thus easy movement and adaptation of the arrangement of the loud speaker module 20 (as part of the communication device 1) to the person wearing the personal protection gear.

In a preferred and non-limiting embodiment, example, or aspect shown in FIG. 4B, the opposite side of swivel mechanism 51 and mounting adapter 52 is illustrated. Here swivel mechanism 51 can, in a preferred and non-limiting embodiment, example, or aspect, be in the form of a latch that can include at one end a receiving element in the form of a hollow cylinder for receiving a cylinder that is part of the mounting adapter 52.

As can be seen, disclosed herein is a preferred and non-limiting embodiment, example, or aspect communication device 1 for use with at least one personal protection system, in particular with a head protection device. In a preferred and non-limiting embodiment, example, or aspect, the communication device 1 can include at least one microphone module 10 and at least one loudspeaker module 20, wherein the microphone module 10 and the loudspeaker module 20 can be flexibly connected to each other by at least one connector 30 that allows for an adjustment of the distance between the microphone module 10 and the loudspeaker module 20, wherein, in a preferred and non-limiting embodiment, example, or aspect, the at least one microphone module 10 can include a housing with at least two sections 11, 12 each one having at least one microphone 13, 14, wherein a first microphone 13 is arranged in at least one of the housing sections 11 and a second microphone 14 is arranged in the other housing section 12. In a preferred and non-limiting embodiment, example, or aspect, the at least two microphones 13, 14 can be arranged in a predetermined distance to each other within the housing. In a preferred and non-limiting embodiment, example, or aspect, at least one housing section 11 with the first microphone 13 can include an insertion mechanism 11a for inserting the first housing section 11 into the loudspeaker module 20 in a first functional mode or for inserting the first housing section into a receiving element 41 mounted to a protective head gear device, in particular a mask 40, in a second functional mode.

In a preferred and non-limiting embodiment, example, or aspect, the at least two housing sections 11, 12 of the microphone module 10 can be designed in a hollow shape, respectively, and the at least two microphones can be placed within the hollow shaped housing sections.

In a preferred and non-limiting embodiment, example, or aspect, automatic switching can occur between the at least two microphones 13, 14 of the microphone module 10 depending on the functional mode being used.

In a preferred and non-limiting embodiment, example, or aspect, one of the at least two microphones 13, 14 of the microphone module 10 can be an electret microphone, condenser microphone or piezoelectric microphone.

In a preferred and non-limiting embodiment, example, or aspect, the at least one connector 30 between the microphone module 10 and the loudspeaker module 20 can include a cable or a wireless connection.

In a preferred and non-limiting embodiment, example, or aspect, the loudspeaker module 20 can include at least one receiving mechanism 20a for receiving the at least one first housing section 11 of the microphone module 10 with the first microphone 13.

In a preferred and non-limiting embodiment, example, or aspect, the loudspeaker module 20 can include at least one further receiving mechanism 20b for detachably connecting the loudspeaker module 20 to at least one holding device 50 that can be attached to a head gear device, such as, in preferred and non-limiting embodiment, example, or aspect, a helmet, a head support system, protective glasses, a half-mask and/or a full-mask device.

Also disclosed herein is a preferred and non-limiting embodiment, example, or aspect mask 40 as part of a protective head gear device for use with the communication device 1. In a preferred and non-limiting embodiment, example, or aspect, the mask can include at least one receiving element 41 on the outer surface of a mask grill 44 of the mask 40 for receiving the first housing section 11 of the microphone module 10 with the first microphone 13. In a preferred and non-limiting embodiment, example, or aspect, the mask can include at least one speech membrane 42 for registering human speech on the inside of the mask 40. In a preferred and non-limiting embodiment, example, or aspect, the mask can include at least one sound transmitting device 43 for funneling the sound from the at least one speech membrane 42, in a preferred and non-limiting embodiment, example, or aspect, through the mask grill to the first microphone 13 of the microphone module 10.

In a preferred and non-limiting embodiment, example, or aspect, the at least one sound transmitting device 42 can be provided as a sound channel, a sound funnel, a wire coupling and/or a wireless coupling.

In a preferred and non-limiting embodiment, example, or aspect, the at least one sound transmitting device 42 can be a sound funnel made of a synthetic material.

Also disclosed herein is a preferred and non-limiting embodiment, example, or aspect holding device 50 for detachably mounting the communication device 1 to at least one head gear device. The holding device 50 can include at least one swivel mechanism 51 for receiving the at least one loudspeaker module 20 of the device 1 and at least one mounting adapter 52 allowing for the mounting of the swivel mechanism with the loudspeaker module to the at least one head gear device.

In a preferred and non-limiting embodiment, example, or aspect, the at least one mounting adapter 52 can be attachable to a helmet, a head support system (head band), protective glasses, a half-mask and/or a full-mask device.

In a preferred and non-limiting embodiment, example, or aspect, the mounting adapter 52 can include a receiving element 52a for receiving the at least one swivel arm 51.

In a preferred and non-limiting embodiment, example, or aspect, the receiving element 52a can be shaped as a hollow cylinder that has at least a partial opening along the height h of the hollow cylinder.

In a preferred and non-limiting embodiment, example, or aspect, at least one swivel mechanism 51 can be shaped as a latch wherein at least one end of the latch is shaped as a cylinder head 51a.

Also disclosed herein is a preferred and non-limiting embodiment, example, or aspect communication device comprising: a loudspeaker module 20; a microphone module 10 comprising a housing including first and second housing sections 11, 12 and first and second microphones 13, 14 in the first and second housing sections; and a connector 30 connecting the loudspeaker module and the microphone module, wherein the first housing section 11 is attached to the loudspeaker module 20 in a first functional mode or to a receiving element 41 of a protective head gear device 40 in a second functional mode.

In a preferred and non-limiting embodiment, example, or aspect, a spatial arrangement between the first and second microphones can be adjusted.

In a preferred and non-limiting embodiment, example, or aspect, the first and second microphones can be arranged a predetermined distance to each other.

In a preferred and non-limiting embodiment, example, or aspect, the first housing section can include an insertion mechanism Ila for insertion into the loudspeaker module.

In a preferred and non-limiting embodiment, example, or aspect, the loudspeaker module can include at least one receiving mechanism 20a for receiving the insertion mechanism of the first housing section in the first functional mode.

In a preferred and non-limiting embodiment, example, or aspect, the first housing section can include an insertion mechanism 11a for insertion into the receiving element 41 of the protective head gear device in the second functional mode.

In a preferred and non-limiting embodiment, example, or aspect, one of the at least two microphones can be an electret microphone, a condenser microphone, or a piezoelectric microphone.

In a preferred and non-limiting embodiment, example, or aspect, the connector 30 between the loudspeaker module and the microphone module can be a cable or a wireless connection.

In a preferred and non-limiting embodiment, example, or aspect, the first and second microphones can be received in the first and second housing sections.

Also disclosed herein is a preferred and non-limiting embodiment, example, or aspect, of a mask 40 for a head gear device, the mask comprising: a receiving element 41 on an outer surface of the mask; a communication device including a loudspeaker module, a microphone module including a housing having first and second housing sections and first and second microphones in the first and second housing sections, and a connector 30 connecting the loudspeaker module and the microphone module, wherein the first housing section is attached to the receiving element on the outer surface of the mask; a speech membrane 42 for registering a sound on the inside of the mask; and a sound transmitting device 43 for funneling the sound from the speech membrane, through a mask grill 44 of the mask to the first microphone of the first housing section attached to the receiving element on an outer surface of the mask.

In a preferred and non-limiting embodiment, example, or aspect, the connector between the microphone module and the loudspeaker module can be a cable or a wireless connection.

In a preferred and non-limiting embodiment, example, or aspect, the sound transmitting device can be a sound channel, a sound funnel, a wire coupling, and/or a wireless coupling.

In a preferred and non-limiting embodiment, example, or aspect, the sound transmitting device can be a sound funnel that can be made of a synthetic material.

In a preferred and non-limiting embodiment, example, or aspect, the loudspeaker module can include at least one receiving mechanism for receiving the first housing section of the microphone module with the first microphone.

Also disclosed herein is a preferred and non-limiting embodiment, example, or aspect of a holding device 50 for a head gear device, the holding device comprising: a swivel mechanism 51 for receiving a receiving element 20b of a loudspeaker module 20 of a communication device 1; and a mounting adapter 52 for mounting the swivel mechanism with the loudspeaker module to the head gear device.

In a preferred and non-limiting embodiment, example, or aspect, the communication device can include a microphone module 10 including a housing having first and second housing sections 11, 12 and first and second microphones 13, 14 in the first and second housing sections, and a connector 30 connecting the loudspeaker module and the microphone module.

In a preferred and non-limiting embodiment, example, or aspect, the head gear device can be a helmet, a head support system, protective glasses, a half-mask, and/or a full-mask device.

In a preferred and non-limiting embodiment, example, or aspect, the mounting adapter can include a receiving element 52a for receiving the swivel mechanism 51.

In a preferred and non-limiting embodiment, example, or aspect, the mounting adapter receiving element 52a can be a hollow cylinder that can have at least a partial opening along a height of the hollow cylinder.

In a preferred and non-limiting embodiment, example, or aspect, the swivel mechanism can be shaped as a latch wherein at least one end of the latch can be shaped as a cylinder head.

Although the invention has been described in detail for the purpose of illustration based on what is currently considered to be the most practical and preferred embodiments, examples, or aspects, it is to be understood that such detail is solely for that purpose and that the invention is not limited to the disclosed embodiments, examples, or aspects, but, on the contrary, is intended to cover modifications and equivalent arrangements that are within the spirit and scope of the appended claims. For example, it is to be understood that the present invention contemplates that, to the extent possible, one or more features of any preferred and non-limiting embodiment, example, or aspect can be combined with one or more features of any other preferred and non-limiting embodiment, example, or aspect.

1-15. (canceled)

16. A communication device comprising:
a loudspeaker module;
a microphone module comprising a housing including first and second housing sections and first and second microphones in the first and second housing sections; and
a connector connecting the loudspeaker module and the microphone module, wherein the first housing section is attached to the loudspeaker module in a first functional mode or to a receiving element of a protective head gear device in a second functional mode.

17. The communication device of claim 16, wherein a spatial arrangement between the first and second microphones is adjustable.

18. The communication device of claim 16, wherein the first and second microphones are arranged a predetermined distance to each other.

19. The communication device of claim 16, wherein the first housing section includes an insertion mechanism for insertion into the loudspeaker module.

20. The communication device of claim 16, wherein the loudspeaker module includes at least one receiving mechanism for receiving the insertion mechanism of the first housing section in the first functional mode.

21. The communication device of claim 16, wherein the first housing section includes an insertion mechanism for insertion into the receiving element of the protective head gear device in the second functional mode.

22. The communication device of claim 16, wherein one of the first and second microphones is an electret microphone, a condenser microphone, or a piezoelectric microphone.

23. The communication device of claim 16, wherein the connector between the loudspeaker module and the microphone module comprises a cable or a wireless connection.

24. The communication device of claim 16, wherein the first and second microphones are received in the first and second housing sections.

25. A mask for a head gear device, the mask comprising:
a receiving element on an outer surface of the mask;
a communication device including a loudspeaker module, a microphone module including a housing having first and second housing sections and first and second microphones in the first and second housing sections, and a connector connecting the loudspeaker module and the microphone module, wherein the first housing section is attached to the receiving element on the outer surface of the mask;
a speech membrane for registering a sound on the inside of the mask; and
a sound transmitting device for funneling the sound from the speech membrane, through a mask grill of the mask to the first microphone of the first housing section attached to the receiving element on an outer surface of the mask.

26. The mask of claim 25, wherein the connector between the microphone module and the loudspeaker module comprises a cable or a wireless connection.

27. The mask of claim 25, wherein the sound transmitting device is as a sound channel, a sound funnel, a wire coupling, and/or a wireless coupling.

28. The mask of claim 25, wherein the sound transmitting device is a sound funnel made of a synthetic material.

29. The mask of claim 25, wherein the loudspeaker module comprises at least one receiving mechanism for receiving the first housing section of the microphone module with the first microphone.

30. A holding device for a head gear device, the holding device comprising:
a swivel mechanism for receiving a receiving element of a loudspeaker module of a communication device; and
a mounting adapter for mounting the swivel mechanism with the loudspeaker module to the head gear device.

31. The holding device of claim 30, wherein the communication device includes a microphone module including a housing having first and second housing sections and first and second microphones in the first and second housing sections, and a connector connecting the loudspeaker module and the microphone module.

32. The holding device of claim 30, wherein the head gear device is a helmet, a head support system, protective glasses, a half-mask, and/or a full-mask device.

33. The holding device of claim 30, wherein the mounting adapter includes a receiving element for receiving the swivel mechanism.

34. The holding device of claim 33, wherein the mounting adapter receiving element is a hollow cylinder that has at least a partial opening along a height of the hollow cylinder.

35. The holding device of claim 30, wherein the swivel mechanism is shaped as a latch wherein at least one end of the latch is shaped as a cylinder head.

36-55. (canceled)
